(19) United States
(12) Patent Application Publication
(10) Pub. No.: US 2009/0321486 A1
(43) Pub. Date: Dec. 31, 2009

(54) ROOF RACK

(76) Inventor: Peter Sloper, Whangarei (NZ)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 12/524,269

(22) PCT Filed: Jan. 31, 2008
(86) PCT No.: PCT/NZ2008/000017

§ 371 Date: Aug. 5, 2009

(30) Foreign Application Priority Data
Jan. 31, 2007 (NZ) 552963

(51) Int. Cl. B60R 9/048

(52) U.S. Cl. 224/324

(57) ABSTRACT

This invention provides a roof rack capable of realisably securing items to the exterior of a vehicle. The roof rack includes a frame for forming a partial enclosure, the frame being attachable to the vehicle; a retaining means pivotally movable within the frame from an open position, allowing access in and out of the frame to a closed position, where an item in the frame is retained, and an engaging and releasing means for releasably engaging the retaining means in the closed position. The advantages of the present invention include ease of use for releasably retaining at least one item to the roof of a vehicle; improved security of items to be retained, and improved safety of retaining items to the roof of a vehicle.

### STATEMENT OF CORRESPONDING APPLICATIONS

This application is based on the Provisional specification filed in relation to New Zealand Patent Application Number 552963, the entire contents of which are incorporated herein by reference.

### TECHNICAL FIELD

The present invention relates to a roof rack. In particular, the present invention relates to a roof rack capable of realisably securing items to the exterior of a vehicle.

### BACKGROUND ART

Vehicle roof racks provide additional storage space for a variety of items such as ladders, poles, skis, bicycles and luggage. Typical roof racks comprise at least two parallel bars extending across the width of the vehicle, these bars being immobile and rigidly secured to the roof of the vehicle. The items are placed across the bars and secured to the bars with straps, rope, or cords or similar.

One disadvantage with these roof racks and securing means is their difficulty of use which requires passing the securing means over the items to be secured and tying securing knots, or placing hooks on the roof rack bars at convenient positions. In addition, elasticised cords with associated hooks (‘bungee cords’) can be a safety risk to the user if they become unsecured after being tightly stretched over an item to be secured.

In addition, securing means such as straps, rope, cords or similar can sometimes provide a lack of security of secured items if their method of attachment to the roof rack bars, such as knots or hooks becomes unsecured during vehicle transit or if, after placing the items to be secured on the roof rack, the user forgets to attach them before driving the vehicle. This can result in an additional safety risk.

It would therefore be an advantage if there could be provided a roof rack which combines a roof rack and a securing means which is easily used, offers improved security and improved safety of use over existing roof racks/securing means.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a roof rack for a vehicle, said roof rack including:
a frame for forming a partial enclosure, said frame being attachable to said vehicle;
a retaining means pivotally movable within the frame from an open position allowing access in and out of said frame to a closed position where an item in said frame is retained, and
an engaging and releasing means for releasably engaging said retaining means in the closed position.

Preferably, the retaining means may include two portions, and wherein pressure against the first portion of said retaining means causes pivoting of said retaining means and movement of the second portion of said retaining means to be engaged by the engaging and releasing means.

Preferably, the pressure exerted against the first portion of said retaining means is exerted by the item to be retained.

Preferably, the engaging and releasing means may be spring loaded to be biased in an engaging position.

According to a second aspect of the present invention there is provided a method of realisably securing an item to a roof rack, said roof rack including:
a frame for forming a partial enclosure, said frame being attachable to a vehicle;
a retaining means pivotally movable within the frame from an open position allowing access in and out of said frame to a closed position where the item in said frame is retained, said retaining means including two portions, and
an engaging and releasing means for releasably engaging said retaining means in the closed position
wherein pressure against the first portion of said retaining means causes pivoting of said retaining means and movement of the second portion of said retaining means to be engaged by the retaining and releasing means

the method includes the steps:
positioning the item to be retained on the second portion of the retaining means when said retaining means is in the open position, and
exerting pressure on the first portion of the retaining means in a horizontal direction causes pivoting of said retaining means and movement of said second portion of said retaining means to be engaged by the engaging and releasing means when said retaining means is in the closed position.

Preferably, the method also includes the steps:
engaging the engaging and releasing means to release the second portion of the retaining means, and
removing the item from the second portion of the retaining means when said retaining means is in the open position.

### BRIEF DESCRIPTION OF DRAWINGS

Further aspects of the present invention will become apparent from the ensuing description which is given by way of example only and with reference to the accompanying drawings in which:

FIG. 1 shows a side view of a preferred embodiment of the roof rack;

FIG. 2 shows a plan view of the roof rack of the embodiment shown in FIG. 1, and

FIG. 3 shows a side elevation view of an arrangement of two roof racks of the embodiment shown in FIG. 1 attached to a vehicle roof.

### BEST MODES FOR CARRYING OUT THE INVENTION

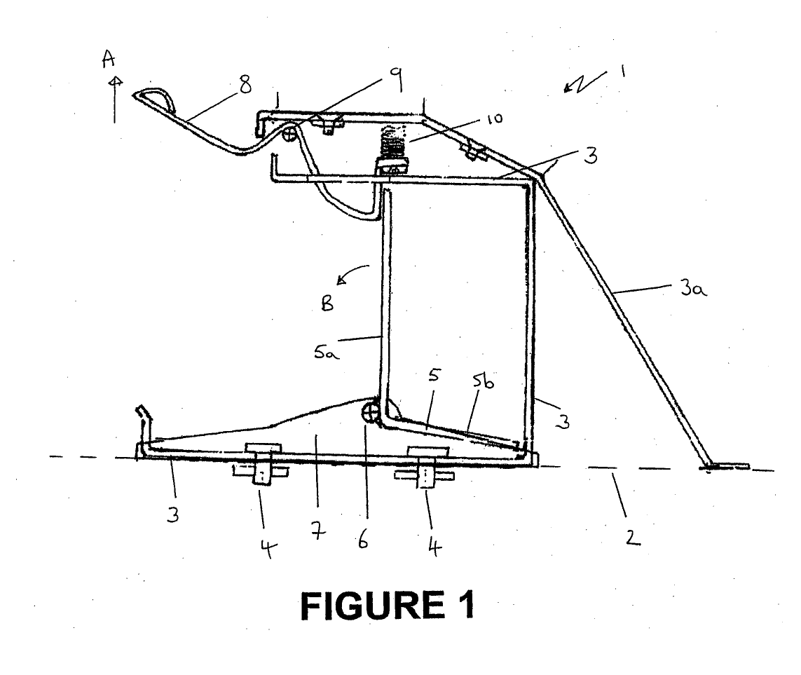

The invention is now described in relation to one preferred embodiment of the present invention as shown in FIGS. 1 to 3. It should be appreciated that the invention may be varied from the Figures without departing from the scope of the invention.

Referring to FIGS. 1 to 3, there is shown a roof rack generally indicated by arrow 1. The roof rack 1 may be used to secure items such as a ladder, bicycle, skis, kayak, luggage, poles and so forth to the roof of a vehicle 2. The following description illustrates a roof rack adapted to secure one end of a ladder, although it will be readily appreciated that this is exemplary only.

The roof rack 1 includes a frame 3 in a substantially c-shape.

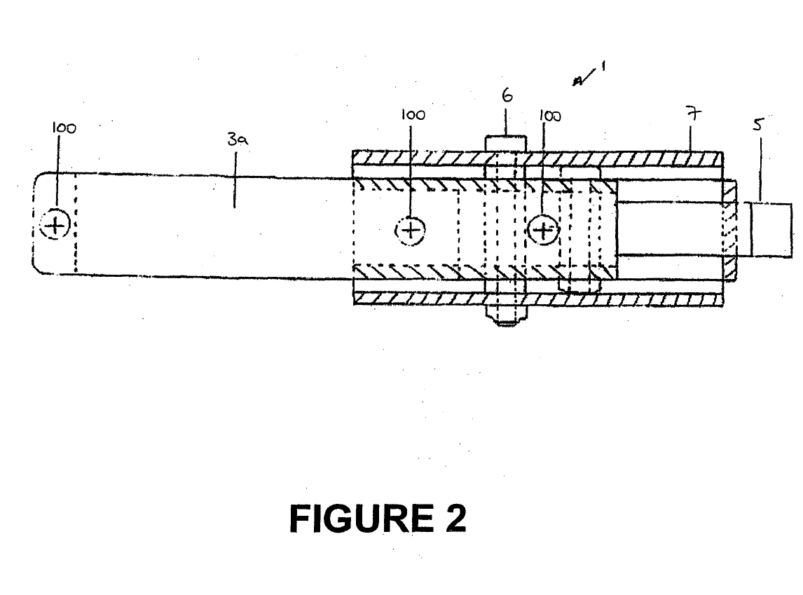

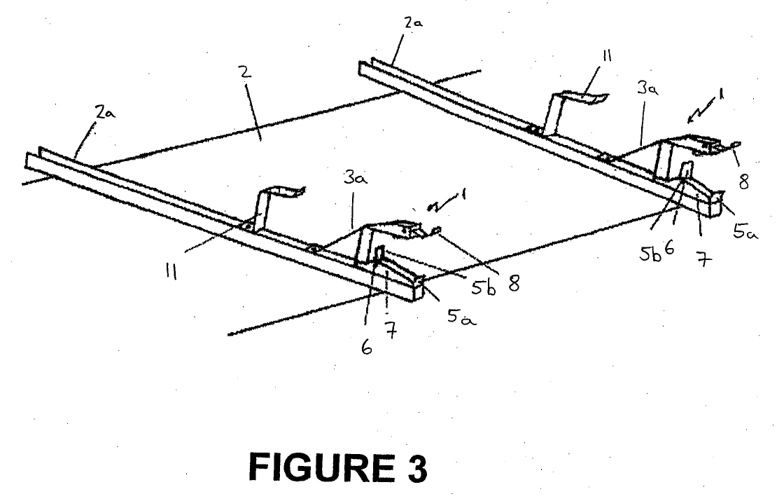

The frame 3 may be adapted to be releasably secured to a vehicle roof 2 directly via fixing means such as screws 100 (shown in FIG. 2), bolts or the like or may be adapted to be detachably secured to existing vehicle roof bars 2a (as shown in FIG. 3) via fastening means such as clamps 4. Optionally there may be provided adjustment of the spacing between the securing means.

The roof rack 1 includes a retaining means 5 including two portions 5a and 5b the retaining means is in the form of an L-shaped bar which pivots about pivot 6 attached to a body 7. FIG. 1 shows the retaining means 5 in a closed position capable of retaining an item as a result of engagement of portion 5a of the retaining means 5 with an engaging and releasing means 8 in the form of a release lever. Biasing of the engaging and releasing means 8 upwards by a user in the direction of arrow A causes movement of the engaging and releasing means 8 about pivot 9 to compress the spring 10 and release the retaining means 5 to allow it to pivot about pivot 6, in the direction of arrow B, to an open position to allow the release the item from the roof rack 1.

The frame 3, retaining means 5 and engaging and releasing means 8 may be bars of circular, square or rectangular cross-section. The securing means 5 may be adapted such that it cannot operate to release an item without a key and associated locking mechanism (not shown) incorporated into the pivot 6 or without some other impediment such as the need to remove the roof rack from the vehicle. In this way there is provided a degree of security preventing unauthorised access to the item.

A stabilising frame portion 3a prevents significant movement of the roof rack 1 when securing the item.

The roof rack 1 may be mounted at any position on the roof of the vehicle 2. The roof rack 1 may be mounted on one side of the roof of the vehicle 2 to allow easy access for a user to retain or release the item.

Referring to FIG. 3 at least one such roof rack may be used to secure each end of an item to the roof of the vehicle 2. A stop 11 limits the movement of the item such as a ladder (not shown) which has the opposite side secured in the roof rack 1.

In use, an item is retained by the roof rack 1 by:
Positioning one side of the item such as a ladder on portion 5a of the retaining means 5 when the retaining means 5 is in an open position so that the ladder sits on its side in a substantially vertical position to the vehicle roof 2;
The ladder is then turned over 90° so that the ladder sits in a substantially horizontal position to the vehicle roof 2, and
This rotation causes pressure to be exerted by the side of the ladder engaged in the roof rack 1 in a horizontal direction which in turn exerts pressure on portion 5b of the retaining means 5 which causes pivoting of said retaining means 5 and engagement of same by the engaging and releasing means 8 causing said retaining means 5 to be held in the closed position.

In use, when an item is to be released from the roof rack 1:
The engaging and releasing means 8 is biased in an upwards direction to release portion 5a of the retaining means 5 which allows the retaining means 5 to pivot to an open position, and
The item is removed from the frame 3 when said retaining means is in the open position.

The roof rack 1 may further include an item-specific fitting (not shown), attached to, or incorporated into the said roof rack 1. The item-specific fitting may be releasably attachable to, or formed integrally with, the roof rack 1 and may take many forms including, but not limited to, ladder holders, bicycle holders, ski/snowboard holders, kayak holders and so forth.

Thus, preferred embodiments of the present invention may have a number of advantages over the prior art which can include:
ease of use for releasibly retaining at least one item to the roof of a vehicle;
improved security of items to be retained, and
improved safety of retaining items to the roof of a vehicle.

Aspects of the present invention have been described by way of example only and it should be appreciated that modifications and additions may be made thereto without departing from the scope thereof as defined in the appended claims.

What I claim is:

1. A roof rack for a vehicle, said roof rack including:
a frame for forming a partial enclosure, said frame being attachable to said vehicle;
a retaining means pivotally movable within the frame from an open position allowing access in and out of said frame to a closed position where an item in said frame is retained, and
an engaging and releasing means for releasably engaging said retaining means in the closed position.

2. A roof rack as claimed in claim 1, wherein the retaining means includes two portions, and wherein pressure against the first portion of said retaining means causes pivoting of said retaining means and movement of the second portion of said retaining means to be engaged by the engaging and releasing means.

3. A roof rack as claimed in claim 2, wherein the pressure exerted against the first portion of said retaining means is exerted by the item to be retained.

4. A roof rack as claimed in any one of claims 1 to 3, wherein the engaging and releasing means is spring loaded to be biased in an engaging position.

5. A method of realisably securing an item to a roof rack, said roof rack including:
a frame for forming a partial enclosure, said frame being attachable to a vehicle;
a retaining means pivotally movable within the frame from an open position allowing access in and out of said frame to a closed position where the item in said frame is retained, said retaining means including two portions, and
an engaging and releasing means for releasably engaging said retaining means in the closed position
wherein pressure against the first portion of said retaining means causes pivoting of said retaining means and movement of the second portion of said retaining means to be engaged by the retaining and releasing means
the method includes the steps:
positioning the item to be retained on the second portion of the retaining means when said retaining means is in the open position, and
exerting pressure on the first portion of the retaining means in a horizontal direction causes pivoting of said retaining means and movement of said second portion of said retaining means to be engaged by the engaging and releasing means when said retaining means is in the closed position.

6. A method of realisably securing an item to a roof rack, as claimed in claim 5 wherein the method also includes the steps:
engaging the engaging and releasing means to release the second portion of the retaining means, and
removing the item from the second portion of the retaining means when said retaining means is in the open position.
